(19) United States
(12) Patent Application Publication
(10) Pub. No.: US 2025/0174788 A1
(43) Pub. Date: May 29, 2025

(54) BATTERY MODULE AND BATTERY MODULE ASSEMBLY METHOD

(71) Applicant: HONDA MOTOR CO., LTD., Tokyo (JP)

(72) Inventors: Daigo KOMATSU, Tokyo (JP); Keiji TAKEUCHI, Tokyo (JP)

(21) Appl. No.: 18/929,630

(22) Filed: Oct. 29, 2024

(30) Foreign Application Priority Data
Nov. 24, 2023 (JP) 2023-199145

(51) Int. Cl. H01M 50/209

(52) U.S. Cl. CPC H01M 50/209; H01M 2220/20

(57) ABSTRACT

A battery module is provided that can reduce the number of components and the occupied volume of accessory components other than battery cells in order to improve the energy efficiency of a battery. In the battery module 200, a one-end-side member of a restraining member 90 is a frame member for restraining a plurality of battery cells 70 stacked in the lateral direction, from an upper side, an other-end-side member is a frame member for restraining the plurality of battery cells 70 stacked in the lateral direction, from a lower side, the one-end-side member and the other-end-side member are joined at a periphery of the plurality of battery cells stacked, and the restraining member 90 restrains the plurality of battery cells 70 stacked in the stack direction.

This application is based on and claims the benefit of priority from Japanese Patent Application No. 2023-199145, filed on 24 Nov. 2023, the content of which is incorporated herein by reference.

### BACKGROUND OF THE INVENTION

### Field of the Invention

The present invention relates to a battery module and a battery module assembly method.

### Related Art

Conventionally, a power storage module or the like that includes a plurality of stacked battery cells has been known (see Patent Documents 1 to 4).
Patent Document 1: Japanese Unexamined Patent Application, Publication No. 2023-055487
Patent Document 2: Japanese Unexamined Patent Application, Publication No. 2021-009786
Patent Document 3: Japanese Unexamined Patent Application, Publication No. 2022-055798
Patent Document 4: Japanese Unexamined Patent Application, Publication No. 2023-060672

### SUMMARY OF THE INVENTION

In the power storage module or the like described above, the number of components of a restraining member that restrains the plurality of battery cells is large. Accordingly, it is required to reduce the number of components and the occupied volume of accessory components other than the battery cells.

The present invention has an object to provide a battery module that can reduce the number of components and the occupied volume of the accessory components other than the battery cells in order to improve the energy efficiency of the battery.

To achieve the object described above, the present invention provides a battery module (e.g., “battery module 200” described later) that includes: a plurality of battery cells (e.g., “battery cells 70” described later) stacked; and a restraining member (e.g., “restraining member 90” described later) configured to restrain the plurality of battery cells stacked, in a stack direction of the plurality of battery cells, in which the restraining member includes a one-end-side member (e.g., “upper member 92” described later), and an other-end-side member (e.g., “lower member 91” described later), to restrain the plurality of battery cells, the one-end-side member is a frame member for restraint from an upper side of the plurality of battery cells stacked in a lateral direction, the other-end-side member is a frame member for restraint from a lower side of the plurality of battery cells stacked in the lateral direction, the one-end-side member and the other-end-side member are joined at a periphery of the battery cells stacked, and the restraining member restrains the plurality of battery cells stacked in the stack direction.

In the invention described above, it is preferable that the stacked battery cells be in a pressed state. Preferably, the one-end-side member and the other-end-side member are joined at a side surface of the periphery of the plurality of battery cells stacked. Preferably, the other-end-side member is positioned outside of the one-end-side member, and is joined to the one-end-side member.

Preferably, the one-end-side member and the other-end-side member are joined by fitting or adhesion. Preferably, the one-end-side member is configured so as to cover upper ends of the plurality of battery cells stacked in the lateral direction, and is open at upper surfaces of the plurality of battery cells stacked in the lateral direction, and the other-end-side member is configured so as to cover lower ends of the plurality of battery cells stacked in the lateral direction, and is open at lower surfaces of the plurality of battery cells stacked in the lateral direction.

Preferably, a stack-direction end of the restraining member that restrains the plurality of battery cells stacked is open. Preferably, the other-end-side member is configured so as to cover from lower ends to side surfaces of the plurality of battery cells stacked in the lateral direction, and an upper end of the other-end-side member is positioned above an upper surface of the one-end-side member. Preferably, an upper end of the other-end-side member includes a protrusion (e.g., “protrusions 916” described later) positioned above an upper surface of the one-end-side member.

The present invention provides a battery module assembly method that is an assembly method of assembling a restraining member (e.g., “restraining member 90” described later) that includes a one-end-side member (e.g., “upper member 92” described later) and an other-end-side member (e.g., “lower member 91” described later), to a plurality of battery cells (e.g., “battery cells 70” described later) stacked, the method including: a step of setting the plurality of battery cells in a stacked state, to an assembly jig (e.g., “assembly jig 500” described later); a step of pressing the plurality of battery cells that are set, in a stack direction, by a pressure device (e.g., “pressure jig 505” described later); a step of combining the other-end-side member so as to cover the plurality of battery cells stacked in a lateral direction, from a bottom side, when the plurality of battery cells are compressed to have a predetermined distance by being pressed; a step of combining the one-end-side member that covers upper surfaces of the battery cells stacked in the lateral direction and pressed, from the upper surfaces of the plurality of battery cells; and a step of joining the one-end-side member and the other-end-side member that are combining respectively at tops and bottoms of the battery cells.

Preferably, in the invention described above, a lower side part of the assembly jig includes: a push-up jig (e.g., “push-up jig 503” described later) that includes a push pin (e.g., “push pin 504” described later); and a groove part (e.g., “groove 5031” described later), and the step of combining the other-end-side member sets the other-end-side member in the groove part, pushes up the other-end-side member by the push-up jig that includes the push pin, and combines the plurality of battery cells stacked, with the other-end-side member.

Preferably, the step of pressing presses the plurality of battery cells stacked, from one side or both sides in the stack direction.

Preferably, the step of combining the one-end-side member combines the one-end-side member, from a top side of the plurality of battery cells stacked with which the other-end-side member has been combined at a bottom side, or from the top side of the plurality of battery cells stacked before the other-end-side member has been combined at the bottom side. Preferably, the step of joining the one-end-side member and the other-end-side member joins the one-end-side member and the other-end-side member by fitting or adhesion. Preferably, the one-end-side member and the other-end-side member each constitute a frame body that has an enclosed shape and fixes the plurality of battery cells. Preferably, the other-end-side member includes a grip (e.g., “protrusions 916” described later) that can be gripped when the plurality of battery cells stacked with the restraining member incorporated is stored in a case of the battery module.

According to the present invention, it is possible to provide a battery module that can reduce the number of components and the occupied volume of the accessory components other than the battery cells in order to improve the energy efficiency of the battery.

### BRIEF DESCRIPTION OF THE DRAWINGS

FIG. 1 is a perspective view showing a battery pack according to the present embodiment;

FIG. 2 is a plan view showing the battery pack according to the present embodiment;

FIG. 3 is a sectional view taken along line A-A in FIG. 2;

FIG. 4 is a plan view of a stack-direction end of a battery stack of the battery pack according to the present embodiment;

FIG. 5 is an enlarged perspective view of the stack-direction end of the battery stack of the battery pack according to the present embodiment;

FIG. 6 is an enlarged partial sectional view of the stack-direction end of the battery stack of the battery pack according to the present embodiment;

FIG. 7 is an exploded perspective view showing the battery pack according to the present embodiment;

FIG. 8 is a perspective view showing a battery module of the battery pack according to the present embodiment;

FIG. 9 shows a situation of combining an upper member and a lower member respectively from the top side and bottom side of the battery stack of the battery module according to the present embodiment;

FIG. 10 is a side view showing the battery module according to the present embodiment;

FIG. 11 is a sectional perspective view taken along line B-B in FIG. 10;

FIG. 12 is a sectional perspective view taken along line C-C in FIG. 10;

FIG. 13 is an enlarged perspective view showing the battery module according to the present embodiment;

FIG. 14 is a perspective view showing the battery module in a state before insertion into a case according to the present embodiment;

FIG. 15 is a perspective view showing an assembly jig for combining a restraining member with the battery stack of the battery module according to the present embodiment;

FIG. 16 is a diagram illustrating a situation of combining the restraining member with the battery stack of the battery module according to the present embodiment on the assembly jig;

FIG. 17 is a side sectional view showing a situation of combining the lower member of the restraining member with the battery stack of the battery module according to the present embodiment;

FIG. 18 is a sectional view taken along line D-D in FIG. 17;

FIG. 19 is a diagram illustrating a situation of combining the lower member and the upper member of the restraining member with the battery stack in a pressed state in the battery module according to the present embodiment;

FIG. 20 is a diagram illustrating a situation of combining the restraining member with the battery stack according to the present embodiment;

FIG. 21 is a diagram illustrating a situation of inserting the battery module according to the present embodiment into the case;

FIG. 22 is a diagram illustrating a situation where the battery module according to the present embodiment is inserted in the case;

FIG. 23 is a perspective view showing a situation of inserting the lower member of the restraining member of the battery module according to the present embodiment into a groove formed in an upper surface of a push-up jig;

FIG. 24 is a perspective view showing a situation of disposing the battery stack into the lower member of the restraining member of the battery module according to the present embodiment inserted in the groove formed in the upper surface of the push-up jig;

FIG. 25 is a perspective view showing a situation where the battery stack is disposed in the lower member of the restraining member of the battery module according to the present embodiment inserted in the groove formed in the upper surface of the push-up jig;

FIG. 26 is a perspective view showing a situation of pressing the battery stack disposed in the lower member of the restraining member of the battery module according to the present embodiment, in the stack direction of the battery cells;

FIG. 27 is a sectional view showing a situation of pressing the battery stack disposed in the lower member of the restraining member of the battery module according to the present embodiment, in the stack direction of the battery cells;

FIG. 28 is a perspective view showing a situation where in a state of pressing the battery stack disposed in the lower member of the restraining member of the battery module according to the present embodiment in the stack direction of the battery cells, the lower member is combined from below, and the upper member is combined from above;

FIG. 29 is a sectional view showing the situation where in the state of pressing the battery stack disposed in the lower member of the restraining member of the battery module according to the present embodiment in the stack direction of the battery cells, the lower member is combined from below, and the upper member is combined from above; and

FIG. 30 is a perspective view showing a situation where in the state of combining the lower member and the upper member of the restraining member of the battery module according to the present embodiment with the battery stack, a pressure jig made up of a round bar is retreated from the battery stack.

### DETAILED DESCRIPTION OF THE INVENTION

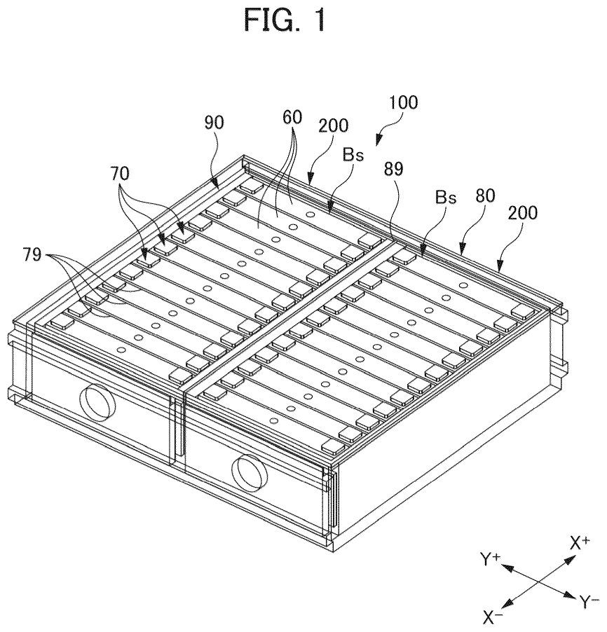

Hereinafter, an embodiment of the present invention is described. As shown in FIG. 1 and the like, a battery pack 100 includes a restraining member 90, a case 80, two battery stacks Bs, flow path members 60, cell restrainer plates 30, and a cover 20.

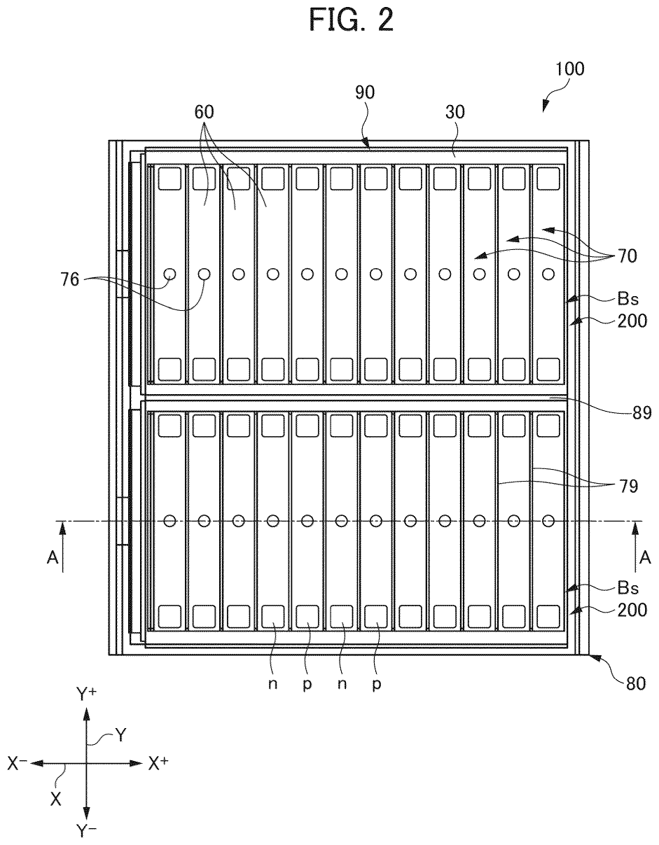

Hereinafter, as shown in FIG. 2 and the like, two predetermined directions orthogonal to each other in a horizontal plane are called “X direction” and “Y direction”. One sense of the X-direction is called “X− direction”, and the opposite sense is called “X+ direction”. One sense of the Y direction is called “Y− direction”, and the opposite sense is called “Y+ direction”.

As shown in FIGS. 1, 2 and the like, the case 80 has a box-type shape and opens upward, and stores two battery stacks Bs arranged in the X direction. The material of the case 80 is a metal or the like.

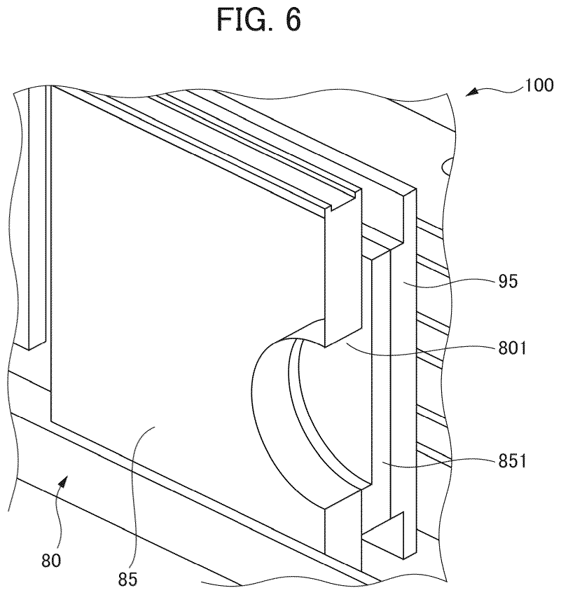

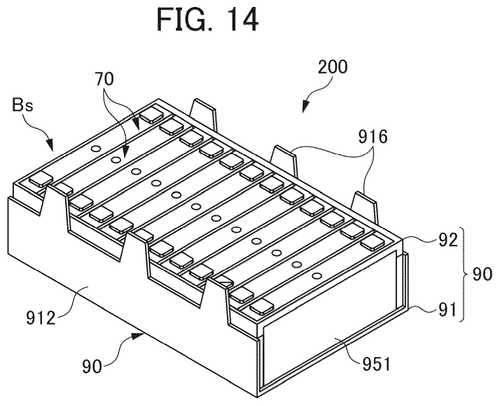

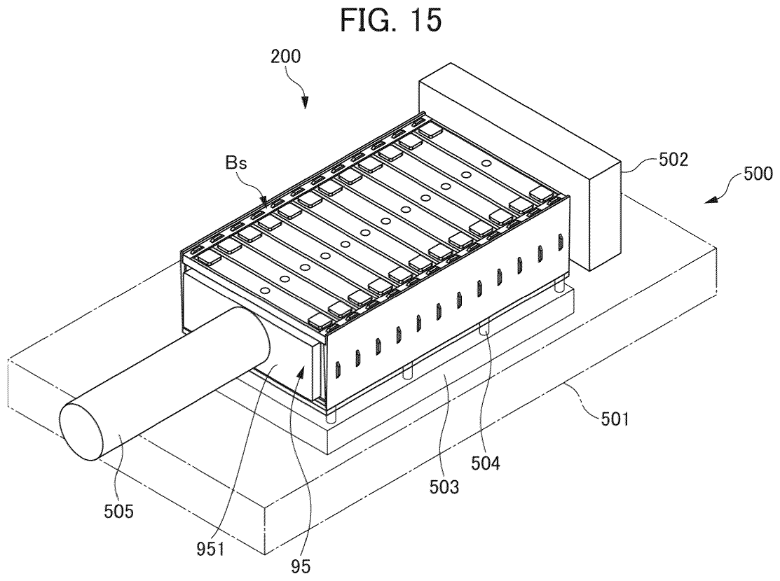

As shown in FIG. 6, in the outer surface (the surface opposite to one facing the battery stacks Bs) of a front wall of the case 80, through-holes 801 are formed that each allow a pressure jig 505 (see FIG. 15 etc.) made up of a press rod, described later, to be inserted therethrough and press the corresponding battery stack Bs via an end plate 95. At a position facing each through-hole 801, a spacer 85 is provided that is a press member for coming into contact with a relatively thick convex-shaped portion of an end plate 95, described later, and pressing this portion against the corresponding battery stack Bs.

At the position of the spacer 85 that faces the corresponding through-hole 801, a disk-shaped concave 851 depressed toward the corresponding battery stack Bs is formed. A pressure relief valve, not shown, is provided in each through-hole 801.

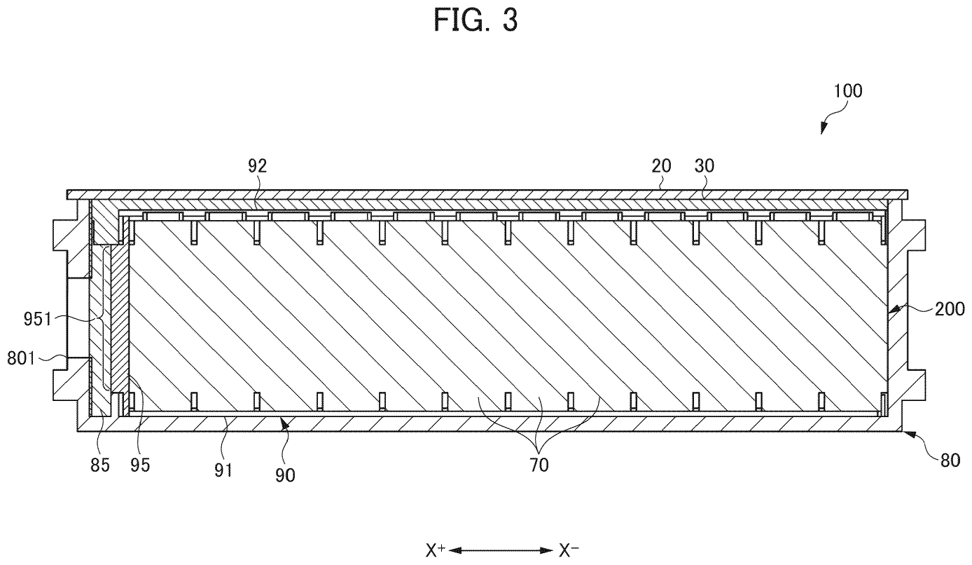

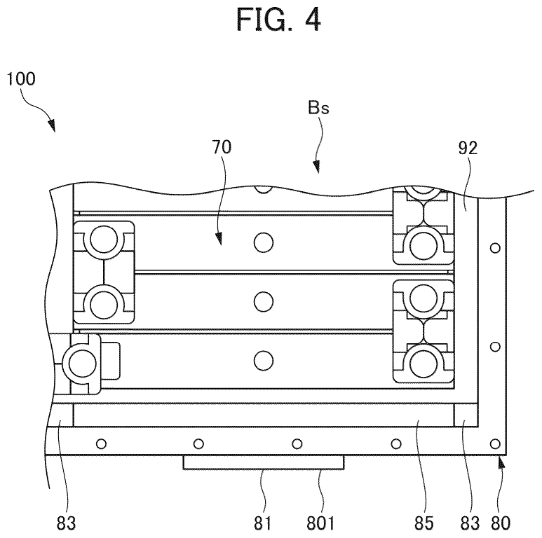

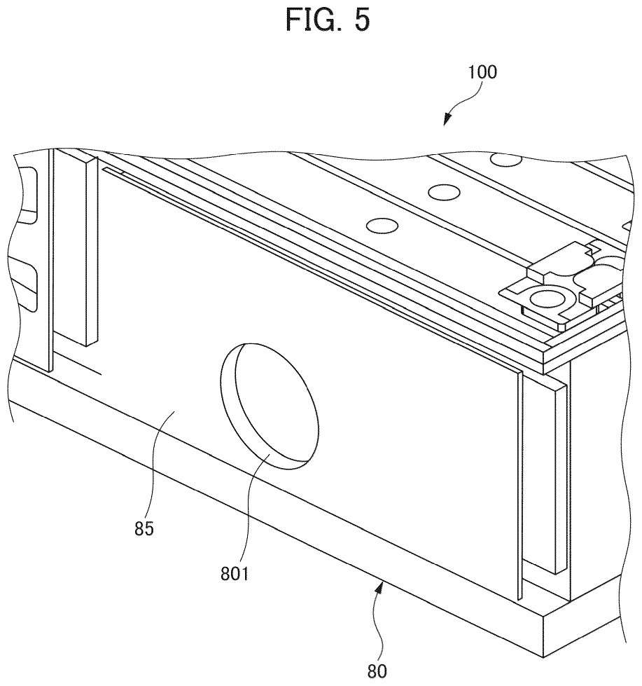

As shown in FIG. 2, each battery stack Bs includes a plurality of battery cells 70 and a plurality of separators 79. Each battery stack Bs is in a state restrained by the restraining member 90, and constitutes the battery module 200. The end plate 95 (see FIG. 3 etc.) is disposed at the stack-direction end of the battery module 200, thus constituting a stacked cell assembly.

Each battery cell 70 has a rectangular outer package elongated in the Y direction. Accordingly, “Y direction” may read “cell longitudinal direction”. In each battery stack Bs, the battery cells 70 are stacked in the X direction. Accordingly, “X direction” may read “stack direction”. Each separator 79 is a plate-shaped member that extends in the Y direction and the vertical direction, and is disposed between each pair of battery cells 70 arranged in the X direction. The material of the separator 79 is a resin or the like.

Between the battery stack Bs on the Y− direction side and the case 80, between the two battery stacks Bs, and between the battery stack Bs on the Y+ direction side and the case 80, plate-shaped spacers 89 extending in the X direction and the vertical direction are respectively installed. The material of the spacer 89 is a resin or the like.

Each battery cell 70 includes a positive electrode p (see FIGS. 2 and 13, etc.) at one end in the Y direction on the upper surface of the outer package, and a negative electrode n (see FIG. 13 etc.) at the other end in the Y direction on the upper surface of the outer package. Specifically, for each of a predetermined plurality of battery cells 70, the positive electrode p is arranged on the Y− direction side, and the negative electrode n is arranged on the Y+ direction side. On the other hand, for the other battery cells 70, the negative electrode n is arranged on the Y− direction side, and the positive electrode p is arranged on the Y+ direction side.

The electrodes p and n of the battery cells 70 adjacent to each other in the Y direction or the X direction are electrically connected by conductive members, not shown. Meanwhile, the positive electrode p of the battery cell 70 on the most electrically plus side is electrically connected to a positive electrode P of the entire battery pack 100 by a conductive member, not shown. The negative electrode n of the battery cell 70 on the most electrically negative side is electrically connected to a negative electrode N of the entire battery pack 100 by another conductive member, not shown. As described above, in the present embodiment, all the battery cells 70 in the battery pack 100 are connected in series.

As shown in FIG. 2, each battery cell 70 includes a safety valve 76 that can discharge the gas in the battery cell 70, at the center on the upper surface of the outer package. Specifically, a portion constituting the safety valve 76 in the upper surface of the outer package of each battery cell 70 is configured to be more fragile than the other portions. Accordingly, when the pressure in the battery cell 70 increases, i.e., when the pressure in the outer package increases, the portion constituting the safety valve 76 in the outer package is the first to be broken, and the pressure is relieved therethrough.

The flow path members 60 are members made of an insulator, such as a resin, and are provided for each battery stack Bs. Each of the flow path members 60 is provided on the upper surfaces of the corresponding battery stack Bs.

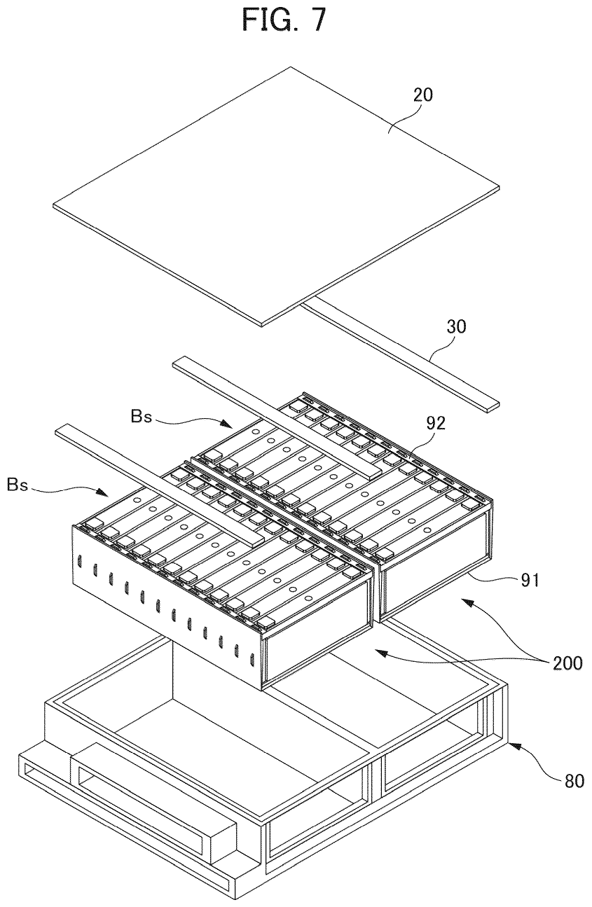

As shown in FIGS. 2, 7 and the like, the cell restrainer plates 30 are elongated plate-shaped members extending in the X direction, and are disposed in parallel with the X direction, at the center positions on the upper surfaces of the pair of battery stacks Bs in the battery pack 100, and at the opposite ends in the Y direction. The cell restrainer plates 30 clamp an after-mentioned varying upper member 92 of the restraining member 90 from above, together with the cover 20, thus accommodating the variation in the heights of the battery cells 70.

The material of each cell restrainer plate 30 is a metal or the like. Flow path formation parts, not shown, through which coolant flows, are formed in portions of the cell restrainer plates 30 that are positioned above the flow path members 60. As shown in FIG. 7 and the like, the cover 20 is formed in a rectangular plate shape, and covers the cell restrainer plates 30 from above. The material of the cover 20 is a metal or the like. The cover 20 constitutes a water jacket for allowing coolant to flow through the flow path members 60.

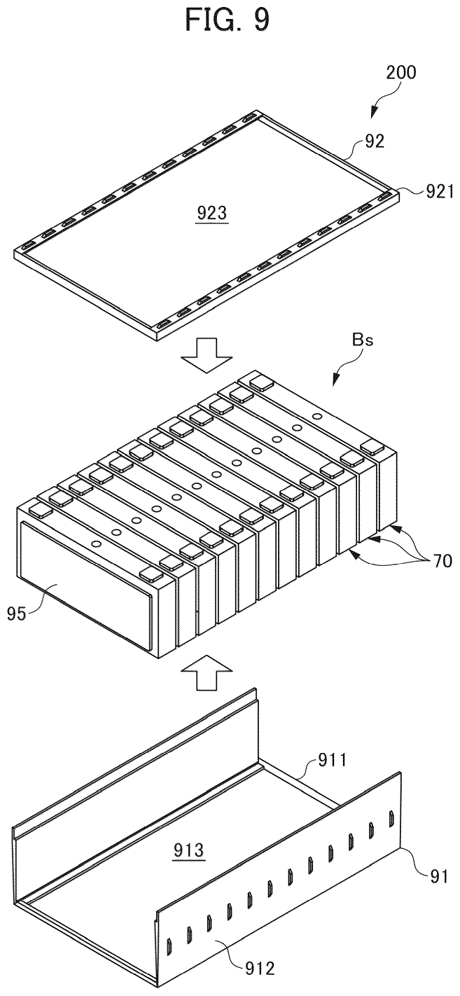

The stacked cell assembly having the configuration where the end plates 95 are disposed at the ends of the battery module 200 in the stack direction (the lateral direction that is the horizontal direction) includes the battery stacks Bs, the restraining members 90, and the end plates 95. As shown in FIG. 9 and the like, the restraining member 90 includes a lower member 91, and an upper member 92. By the restraining member 90, the battery cells 70 in the battery stack Bs are maintained in the pressed state. The lower member 91 includes a rectangular lower frame 911 having an opening 913 that opens at the center, and side walls 912 that stand upward from the pair of long sides of the lower frame 911, and restrains the plurality of battery cells 70 from the bottom side of the battery stack Bs.

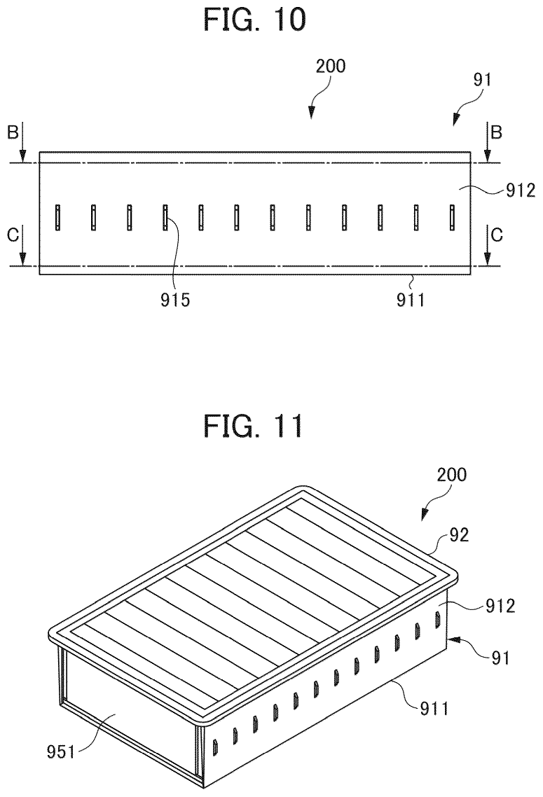

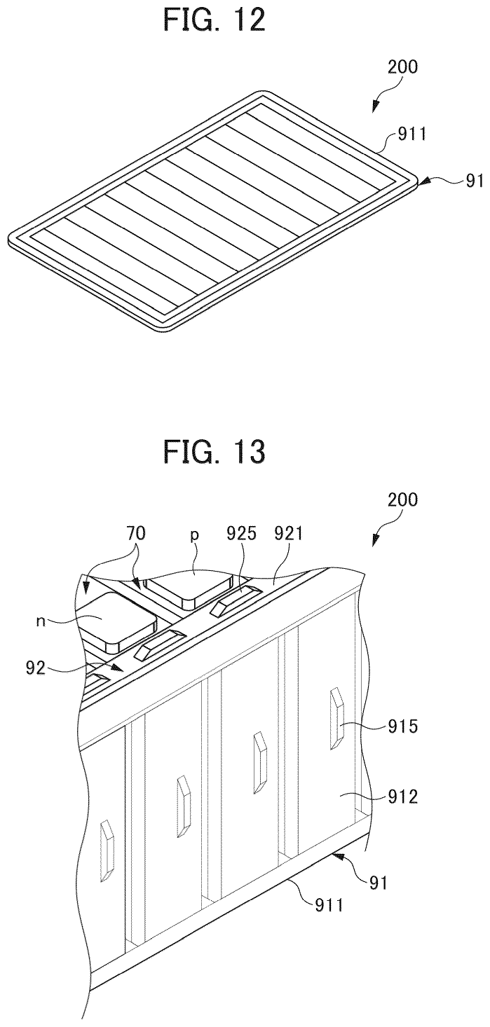

As shown in FIGS. 9, 10, 12 and the like, the lower frame 911 constitutes an enclosed-shaped frame body that is to be laid seamlessly around the periphery of the lower end of the battery stack Bs. According to the configuration, the lower frame 911 is disposed to be combined so as to be laid around the periphery of the lower end of the battery stack Bs, thus allowing the lower frame 911 to restrain the lower end of the battery stack Bs in the stack direction of the plurality of battery cells 70 in the battery stack Bs.

The side walls 912 face and cover the side surfaces of the battery stack Bs from their lower ends to the vicinities of the upper ends of the side surfaces. As shown in FIG. 14, at the upper ends of the side walls 912, a plurality of trapezoidal protrusions 916 are positioned to protrude upward from the upper end edges of side walls 912 above the upper surface of the upper member 92. As shown in FIG. 13, the upper member 92 and the lower member 91 are joined at the side surface of the periphery of the battery stack Bs by fitting or adhesion. The upper member 92 and the lower member 91 are joined, thus allowing the restraining member 90 to have a shape where the upper surface and the lower surface are open at the entire surfaces, and the end surfaces of the opposite ends of the battery stack Bs in the stack direction are open. Note that for the sake of description, in the diagrams other than FIG. 14, the protrusions 916 are omitted.

On the outer surfaces of the side walls 912 there are trapezoidal projections 915 that protrude in the directions away from the outer surfaces of the side walls 912. The projections 915 are configured so as to be appropriately depressible by being pressed toward the inside of the battery stack Bs by the side walls 912 of the lower member 91 from the sides. It is thus configured so that the variation in the lengths of the battery cells 70 in the cell longitudinal direction of the battery cells 70 can be accommodated.

The upper member 92 includes a rectangular upper frame 921 having an opening 923 that opens at the center, and restrains the plurality of battery cells 70 from the top side of the battery stack Bs. As shown in FIGS. 9, 11 and the like, the upper frame 921 constitutes an enclosed-shaped frame body that is to be laid seamlessly around the periphery of the upper end of the battery stack Bs. According to the configuration, the upper frame 921 is disposed to be combined so as to be laid around the periphery of the upper end of the battery stack Bs, thus allowing the upper frame 921 to restrain the upper end of the battery stack Bs in the stack direction of the plurality of battery cells 70 in the battery stack Bs.

On the upper surfaces of the long sides of the upper member 92, as shown in FIG. 13, a plurality of trapezoidal projections 925 protrude upward. The projections 925 are configured to be appropriately depressible by being pressed downward by the cell restrainer plates 30 and the cover 20 from above. Accordingly, the variation in the heights of the battery cells 70 is accommodated.

Each end plate 95 is combined with the stack-direction front of the plurality of battery cells 70 combined with the restraining member 90, i.e., the end surface of the corresponding battery stack Bs in this direction. Specifically, the end plate 95 is formed in the shape of a rectangular plate made of a resin, is fixed between the lower frame 911 and the upper frame 921 of the upper member 92 and the lower member 91 (see FIG. 9 etc.), and the battery stack Bs, and is fixed between the front wall of the case 80 (see FIGS. 3, 6, etc.) and the battery stack Bs.

The peripheral edge of the end plate 95 is configured to be thin. Accordingly, as shown in FIG. 3, the portion other than the peripheral edge includes a convex-shaped portion 951 that is relatively thicker than the peripheral edge. As shown in FIG. 3 etc., the relatively thick convex-shaped portion 951 protrudes in the stack direction from the restraining member 90 through the opening of the end surfaces of the opposite ends of the restraining member 90 in the stack direction of the battery stack Bs. Accordingly, the convex-shaped portion 951 protrudes toward the spacer 85 as a press member for pressing the battery stack Bs with respect to the restraining member 90.

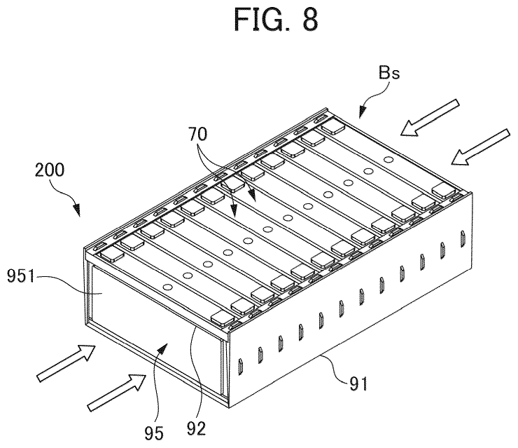

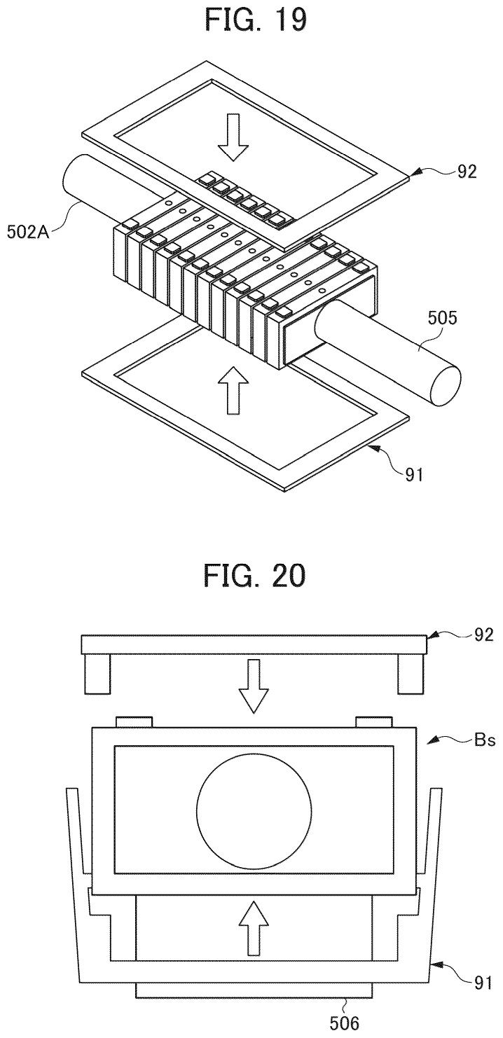

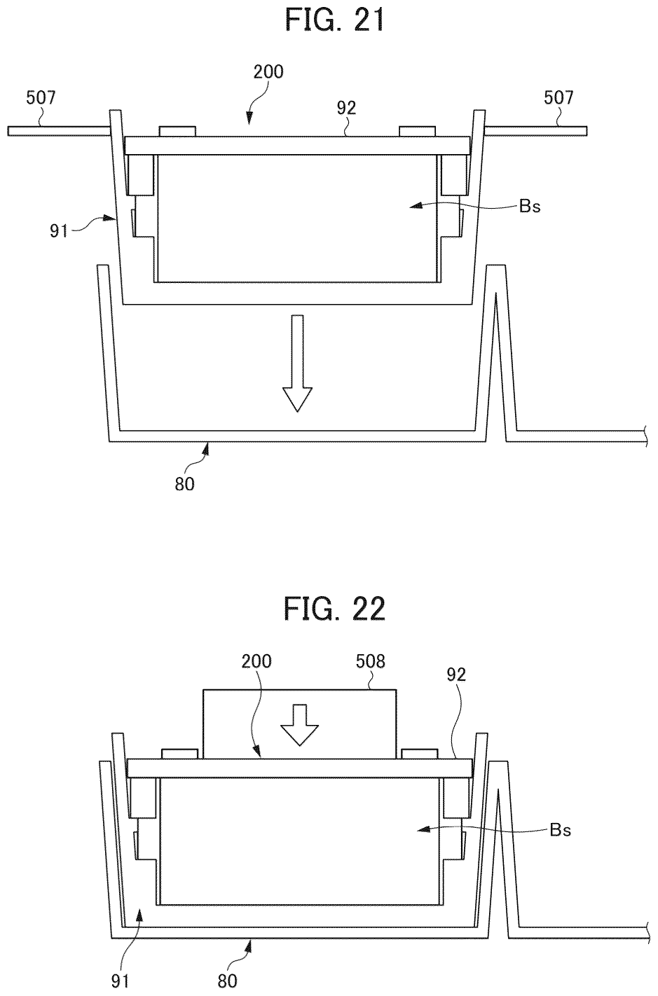

Next, an assembly method for the battery pack 100 having the configuration described above is described. First, an overview (aspect) of the assembly method for the battery pack 100 is described. In the assembly method for the battery pack 100, first, as shown in FIG. 8, the battery module 200 in the state of being restrained by the restraining member 90 in the state where each battery stack Bs is pressed in the stack direction of the battery cells 70 in the battery stack Bs is assembled. That is, as shown in FIG. 19, the upper member 92 and the lower member 91, which constitute the restraining member 90, are combined with the battery stack Bs in the state of being pressed in the stack direction of the battery cells 70, from above with respect to the upper member 92, and from below with respect to the lower member 91, as shown in FIG. 20. Next, as shown in FIG. 21, the protrusions 916 of the lower member 91 are gripped and suspended by grip jigs 507, are inserted into the case 80, and are pushed into the case 80 from above, as shown in FIG. 22.

A specific assembly method for the battery pack 100 is as follows. In the assembly method for the battery pack 100, the assembly jig 500 shown in FIG. 15 is used. The assembly jig 500 includes: a base plate 501; a round bar 502A (see FIGS. 19 and 26 to 30) that constitutes a pressure jig as a press end wall 502 or a pressure device; a push-up jig 503; a push pin 504; and a pressure jig 505 as a pressure device made up of a round bar.

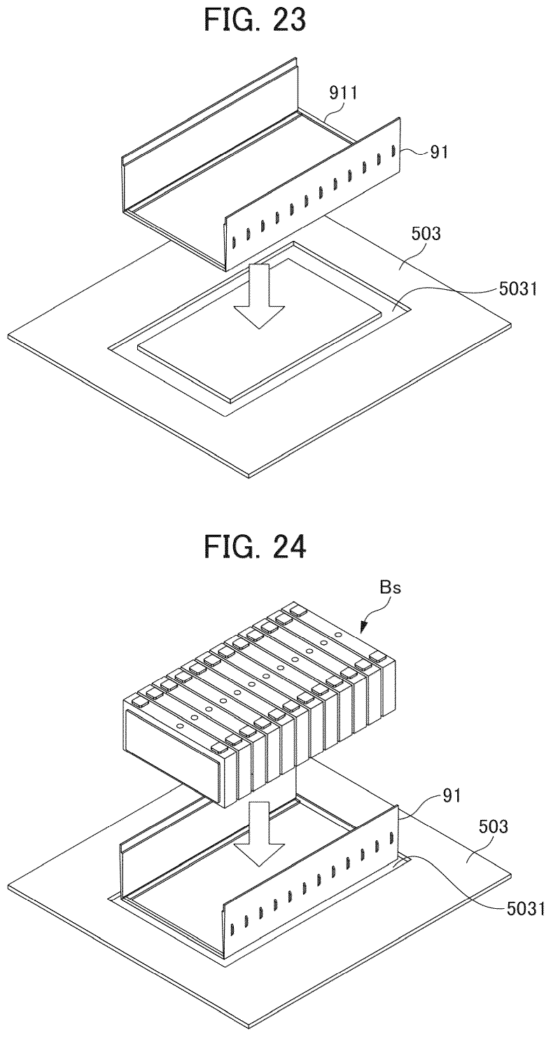

In the assembly method for the battery pack 100, first, as shown in FIG. 23, the lower frame 911 of the lower member 91 is set in a groove 5031 formed in the upper surface of the push-up jig 503. Next, as shown in FIG. 24, the battery stack Bs is inserted into the lower member 91 from the top side of the lower member 91, and as shown in FIG. 25, the battery stack Bs is disposed at a position of allowing the stack to be combined with the lower member 91.

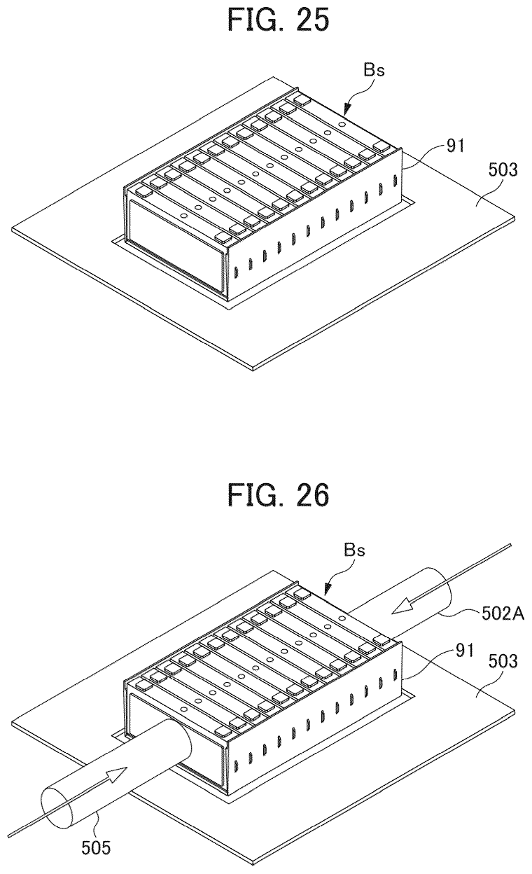

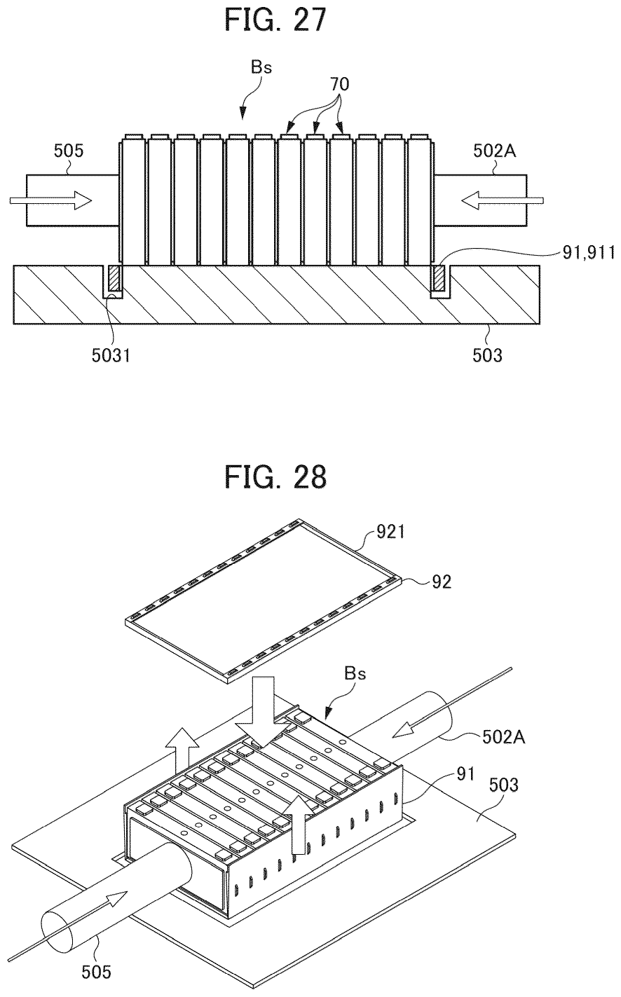

Next, as shown in FIGS. 26 and 27, the battery stack Bs is pressed from the opposite sides in the stack direction, with the battery cells 70 of the battery stack Bs being clamped in the stack direction by the pressure jig 505 and the round bar 502A. The pressure of this pressing ranges from 0.5 to 1.5 KN, inclusive. This is because compressing is insufficient if the pressure is less than 0.5 KN, and the battery cells 70 constituting the battery stack Bs are broken if the pressure exceeds 1.5 KN. Note that in a case where the press end wall 502 (see FIGS. 15 to 18) constituting the pressure jig is used instead of the round bar 502A (see FIGS. 19 and 26 to 30) constituting the pressure jig, the battery stack Bs is pressed from the pressure jig 505 side.

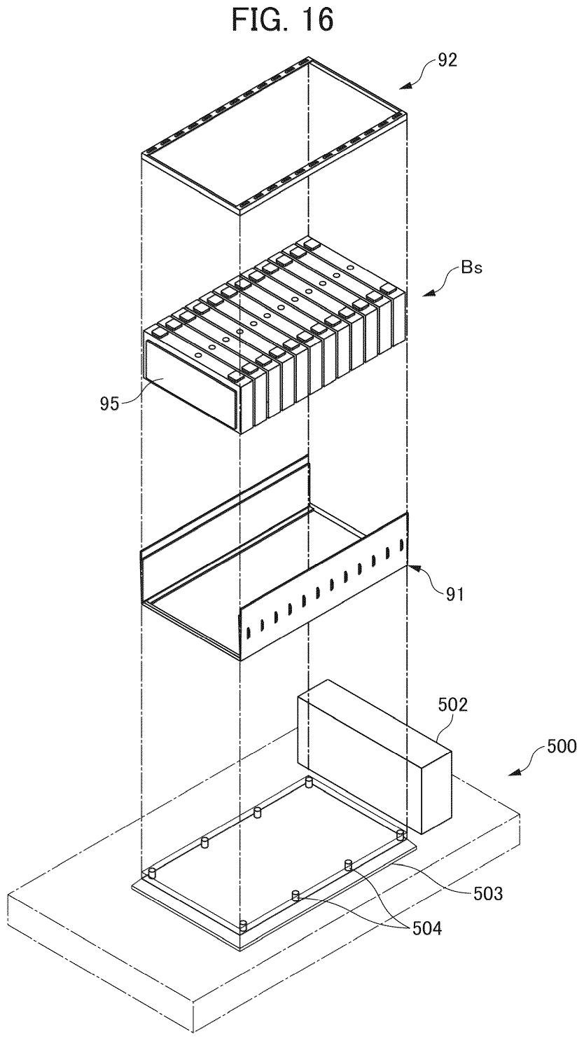

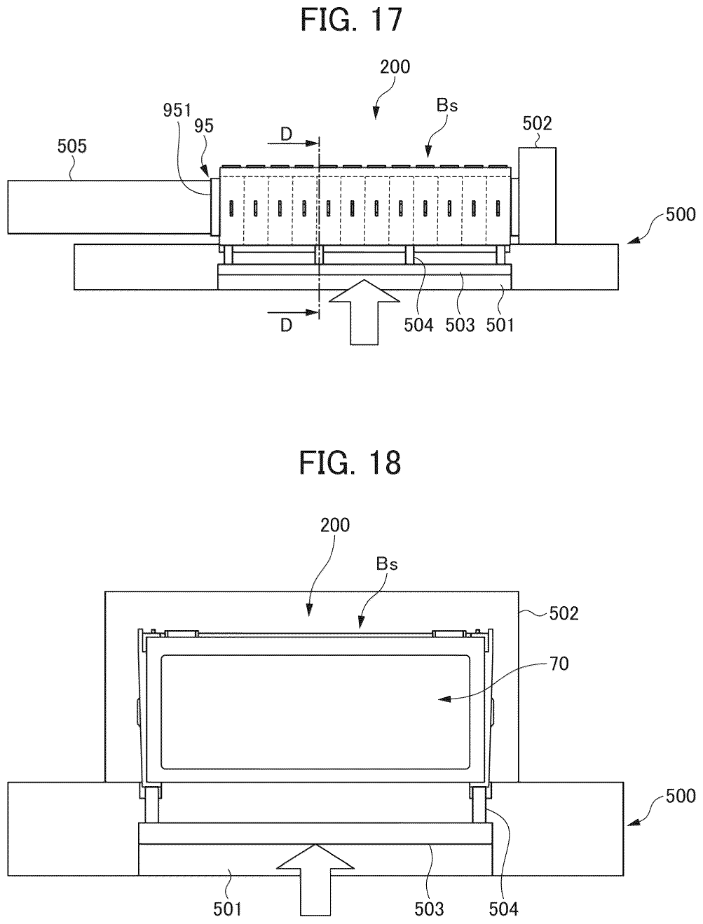

Next, as shown in FIGS. 28 and 29, when the battery stack Bs is compressed to have a predetermined distance by being pressed, the lower member 91 is combined so as to cover, from below, the plurality of battery cells 70 stacked in the horizontal direction, which is the lateral direction. In detail, as shown in FIGS. 17 and 18, the lower member 91 is pushed up and raised by raising the push-up jig 503 and the push pin 504, and the lower member 91 is combined with the battery stack Bs from below.

Next, as shown in FIG. 28, the upper member 92 for covering the upper surfaces of the battery cells 70 is combined from the top side of the pressed battery cells 70 stacked in the horizontal direction as the lateral direction. In detail, as shown in FIGS. 28 and 29, the upper member 92 is combined from the top side of the battery stack Bs so as to cover the entire peripheral edge at the top of the battery stack Bs from the top side of the pressed battery stack Bs.

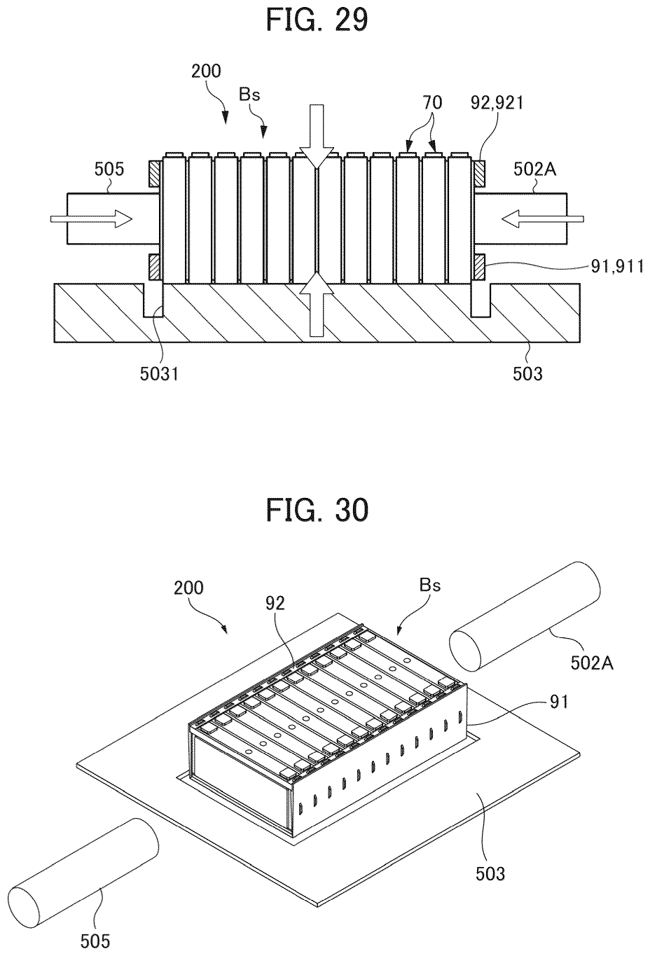

The upper member 92 and the lower member 91 combined with the top and bottom of the battery stack Bs are joined to the side surface of the periphery of the battery stack Bs by fitting or adhesion. As shown in FIG. 30, the pressure jig 505 and the round bar 502A pressing the battery stack Bs clamped therebetween are then separated from each other. The steps described above are steps until completion of assembling the battery module 200 in the assembly method for the battery pack 100. Note that on the outer surface of the end of the battery stack Bs in the stack direction, the end plate 95 is disposed in a state where its thick portion protrudes from the restraining member 90. Subsequently, the battery module 200 is incorporated in the case 80, thus completing assembly of the battery pack 100.

Advantageous effects of the embodiment described above are as follows. In the present embodiment, the restraining member 90 of the battery module 200 constituting the battery pack 100 includes the upper member 92, and the lower member 91. The upper member 92 is a frame member that restrains the plurality of battery cells 70 stacked in the lateral direction from above. The lower member 91 is a frame member that restrains the plurality of battery cells 70 stacked in the lateral direction from below. The restraining member 90 restrains the plurality of stacked battery cells 70 in the stack direction.

Thus, in the state where the plurality of battery cells 70 are compressed, they can be fixed in a state of being restrained by the restraining member 90 as the frame body. Accordingly, the occupied volume of accessory components other than the battery cells 70 in the IPU (intelligent power unit) can be reduced, the cell filling factor can be improved, and the cruising range of a BEV (battery electric vehicle) can be increased. In particular, the upper member 92 and the lower member 91 are made up of the seamless frame bodies combined with the plurality of stacked battery cells 70, thus allowing secure restraint by the restraining member 90.

In the present embodiment, the upper member 92 and the lower member 91 of the battery module 200 are joined at the side surface of the periphery of the plurality of stacked battery cells 70 by fitting or adhesion. Thus, the lower member 91 can be configured to be positioned outside of the upper member 92, and be joined to the upper member 92. Accordingly, the lower member 91 can be used not only for restraint as the restraining member 90, but also for, e.g., conveying the battery module 200 with a configuration of having the protrusions 916 at the upper end of the lower member 91 and allowing the protrusions 916 to be gripped. By adopting an upper and lower integrated structure of the restraining member 90, the number of components can be reduced, and cost reduction can be facilitated.

In the present embodiment, the upper member 92 is configured so as to cover the upper ends of the plurality of battery cells 70 stacked in the lateral direction, and is open at the upper surfaces of the plurality of battery cells 70 stacked in the lateral direction. The lower member 91 is configured so as to cover the lower ends of the plurality of battery cells stacked in the lateral direction, and is open at the lower surfaces of the battery cells stacked in the lateral direction. The stack-direction end of the restraining member 90, which restrains the plurality of stacked battery cells 70, is open.

Thus, the frame body structure that covers the upper and lower ends of the entire battery stack Bs including the battery cells 70 and restrains them can be achieved. When the reaction force is reduced by compression of the battery cells 70, the restraining member 90 can be prevented from moving with respect to the battery cells 70 of the battery stack Bs.

According to the present embodiment, the battery module 200 assembly method includes: a step of setting the plurality of battery cells 70 in a stacked state, to an assembly jig 500; a step of pressing the plurality of battery cells 70 that are set, in a stack direction, by a pressure jig 505 as a pressure device; a step of combining the lower member 91 so as to cover the plurality of battery cells 70 stacked in the horizontal direction that is the lateral direction, from below, when the plurality of battery cells 70 are compressed to have a predetermined distance by being pressed; a step of combining the upper member 92 that covers upper surfaces of the battery cells 70, from the upper surfaces of the plurality of battery cells 70 stacked in the lateral direction and pressed; and a step of joining the upper member 92 and the lower member 91 that are combined respectively at tops and bottoms of the battery cells 70.

More specifically, for example, the lower side part of the assembly jig 500 includes: a push-up jig 503 that includes a push pin 504 as a push pin; and a groove 5031 as a groove part, and the step of combining the lower member 91 sets the lower member 91 in the groove 5031, pushes up the lower member 91 by the push-up jig 503 that includes the push pin 504, and combines the plurality of stacked battery cells 70, in the lower member 91. Thus, fixation to the restraining member 90 can be achieved without lifting the battery stack Bs as the stacked battery cells 70. Accordingly, the battery module 200 having a favorable combining property can be achieved.

According to the present embodiment, the step of pressing the battery cells 70 fixes the plurality of stacked battery cells 70 to the assembly jig 500, and presses and compresses them at a pressure ranging from 0.5 to 1.5 KN, inclusive, with the pressure jig 505. Accordingly, the total length of the battery stack Bs that includes the plurality of stacked battery cells 70 can be appropriately compressed to a predetermined distance (predetermined length).

According to the present embodiment, the step of pressing the battery stack Bs presses the plurality of stacked battery cells 70, from one side or both sides in the stack direction. Accordingly, the battery stack Bs can be appropriately pressed from one side or both sides.

According to the present embodiment, the step of combining the lower member 91 raises the lower member 91 from the lower side part of the assembly jig 500, and combines it from the bottom side of the plurality of stacked battery cells 70. More specifically, the step of combining the lower member 91 raises the lower member 91 by the push pin 504 of the assembly jig 500. Thus, the configuration of raising the lower member 91 without lowering the battery stack Bs can be achieved. Accordingly, the configuration of the assembly jig 500 can be prevented from being complicated.

According to the present embodiment, the step of combining the upper member 92 combines the upper member 92 from the top side of the plurality of stacked battery cells 70 with which the lower member 91 is combined at the bottom side. Thus, the configuration of the assembly jig 500 for allowing the upper member 92 to be combined from above without raising the battery stack Bs can be prevented from being complicated.

According to the present embodiment, the step of joining the upper member 92 and the lower member 91 joins the upper member 92 and the lower member 91 by fitting or adhesion. Accordingly, by adopting the upper and lower integrated structure of the restraining member 90, the number of components can be reduced, and cost reduction can be facilitated.

According to the present embodiment, in the battery pack 100, the end plate 95 is provided on the outer surface of the stacked cell assembly in the stack direction of the plurality of battery cells 70. The outer surface of the end plate 95 is in contact with the pressure jig 505 as the pressure device that presses the stacked cell assembly. The outer surface of the end plate 95 in contact with the pressure jig 505 includes a convex-shaped portion 951 as the convex-shaped part toward the pressure jig 505.

Thus, by pressing the convex-shaped portion 951, the compression load by pressing is applied to the entire surface of the end plate 95 on the opposite side of the convex-shaped portion 951 side in the stack direction of the battery cells 70 of the battery stack Bs. Accordingly, integral pressing with the end plate 95 can uniformly press the stacked cell assembly. When the stacked cell assembly is uniformly pressed by pressing the convex-shaped portion 951 of the end plate 95, a limited range at the center of the battery cells 70 can be pressed, and the stacked cell assembly can be uniformly pressed as described above. Before incorporation into the case 80, the convex-shaped portion 951 can be pressed, and the plurality of battery cells 70 can be compressed. Accordingly, limitations in mass production can be reduced.

According to the present embodiment, the end plate 95 is combined with the stack-direction end surface of the plurality of battery cells 70 combined with the restraining member 90. The end plate 95 is fixed between the upper frame 921 and the lower frame 911 as the frames of the upper member 92 and the lower member 91, and the battery cells 70. The portion 951 as the convex-shaped part of the end plate 95 protrudes toward the pressure jig 505 as the press member with respect to the restraining member 90.

Accordingly, by pressing the portion 951 as the convex-shaped part toward the battery cells 70, the battery cells 70 of the battery stack Bs can be uniformly pressed over the entire surface on the end plate 95 side opposite to the portion 951 as the convex-shaped part.

Note that the present invention is not limited to the embodiment. Modifications, improvements and the like in a range of allowing achievement of the object of the present invention are encompassed in the present invention. For example, the restraining member may have a configuration that includes a member forming a pair of one side and the other side in a direction other than the vertical direction, for example, in the left and right direction, instead of the lower member 91 and the upper member 92. The step of combining the upper member 92 may combine the upper member 92 from the top side of the plurality of stacked battery cells before the lower member 91 has been combined at the bottom side, instead of combining the upper member 92 from the top side of the plurality of stacked battery cells with which the lower member 91 has already been combined at the bottom side.

### EXPLANATION OF REFERENCE NUMERALS

70 Battery cell
80 Case (storage case)
85 Spacer
90 Restraining member (cell assembly case)
91 Lower member (other-end-side member)
92 Upper member (one-end-side member)
95 End plate
100 Battery pack
200 Battery module
500 Assembly jig
504 Push pin
505 Pressure jig (pressure device)
801 Through-hole
913, 923 Opening
916 Protrusion (grip)
951 Convex-shaped portion (convex-shaped part)

What is claimed is:

1. A battery module comprising:
a plurality of battery cells stacked; and
a restraining member configured to restrain the plurality of battery cells stacked, in a stack direction of the plurality of battery cells,
wherein the restraining member includes a one-end-side member, and an other-end-side member, to restrain the plurality of battery cells,
the one-end-side member is a frame member for restraint from an upper side of the plurality of battery cells stacked in a lateral direction,
the other-end-side member is a frame member for restraint from a lower side of the plurality of battery cells stacked in the lateral direction,
the one-end-side member and the other-end-side member are joined at a periphery of the plurality of battery cells stacked, and
the restraining member restrains the plurality of battery cells stacked, in the stack direction.

2. The battery module according to claim 1, wherein the plurality of battery cells stacked are in a pressed state.

3. The battery module according to claim 1, wherein the one-end-side member and the other-end-side member are joined at a side surface of the periphery of the plurality of battery cells stacked.

4. The battery module according to claim 3, wherein the other-end-side member is positioned outside of the one-end-side member, and is joined to the one-end-side member.

5. The battery module according to claim 1, wherein the one-end-side member and the other-end-side member are joined by fitting or adhesion.

6. The battery module according to claim 1,
wherein the one-end-side member is configured so as to cover upper ends of the plurality of battery cells stacked in the lateral direction, and is open at upper surfaces of the plurality of battery cells stacked in the lateral direction, and
the other-end-side member is configured so as to cover lower ends of the plurality of battery cells stacked in the lateral direction, and is open at lower surfaces of the plurality of battery cells stacked in the lateral direction.

7. The battery module according to claim 1, wherein a stack-direction end of the restraining member that restrains the plurality of battery cells stacked is open.

8. The battery module according to claim 1, wherein the other-end-side member is configured so as to cover from lower ends to side surfaces of the plurality of battery cells stacked in the lateral direction, and an upper end of the other-end-side member is positioned above an upper surface of the one-end-side member.

9. The battery module according to claim 8, wherein an upper end of the other-end-side member includes a protrusion positioned above an upper surface of the one-end-side member.

10. A battery module assembly method that is an assembly method of assembling a restraining member that includes a one-end-side member and an other-end-side member, to a plurality of battery cells stacked, the method comprising:
a step of setting the plurality of battery cells in a stacked state, to an assembly jig;
a step of pressing the plurality of battery cells that are set, in a stack direction, by a pressure device;
a step of combining the other-end-side member so as to cover the plurality of battery cells stacked in a lateral direction, from below, when the plurality of battery cells is compressed to have a predetermined distance by being pressed;
a step of combining the one-end-side member that covers upper surfaces of the battery cells stacked in the lateral direction and pressed, from the upper surfaces of the plurality of battery cells; and
a step of joining the one-end-side member and the other-end-side member that are combined respectively at tops and bottoms of the battery cells.

11. The battery module assembly method according to claim 10,
wherein a lower side part of the assembly jig includes: a push-up jig that includes a push pin; and a groove part,
and the step of combining the other-end-side member sets the other-end-side member in the groove part, pushes up the other-end-side member by the push-up jig that includes the push pin, and combines the plurality of battery cells stacked, with the other-end-side member.

12. The battery module assembly method according to claim 10, wherein the step of pressing presses the plurality of battery cells stacked, from one side or both sides in the stack direction.

13. The battery module assembly method according to claim 11, wherein the step of combining the one-end-side member combines the one-end-side member, from a top side of the plurality of battery cells stacked with which the other-end-side member has been combined at a bottom side, or from the top side of the plurality of battery cells stacked before the other-end-side member has been combined at the bottom side.

14. The battery module assembly method according to claim 10, wherein the step of joining the one-end-side member and the other-end-side member joins the one-end-side member and the other-end-side member by fitting or adhesion.

15. The battery module assembly method according to claim 10, wherein the one-end-side member and the other-end-side member each constitute a frame body that has an enclosed shape and fixes the plurality of battery cells.

16. The battery module assembly method according to claim 10, wherein the other-end-side member includes a grip that can be gripped when the plurality of battery cells stacked with the restraining member incorporated is stored in a case of the battery module.
